(19) United States
(12) Patent Application Publication
(10) Pub. No.: US 2024/0349848 A1
(43) Pub. Date: Oct. 24, 2024

(54) SURFACE FASTENER

(71) Applicant: YKK Corporation, Tokyo (JP)

(72) Inventors: Yui Miyawaki, Toyama-ken (JP); Isamu Michihata, Toyama-Ken (JP); Peng Li, Toyama-Ken (JP); Wataru Kuriyama, Toyama-Ken (JP); Shinichi Daijogo, Toyama-Ken (JP)

(21) Appl. No.: 18/632,918

(22) Filed: Apr. 11, 2024

(30) Foreign Application Priority Data
Apr. 19, 2023 (JP) 2023-068640

(51) Int. Cl. A44B 18/00

(52) U.S. Cl. CPC A44B 18/0065

(57) ABSTRACT

In a surface fastener according to the present invention, a plurality of the hook groups and a spaced part provided between adjacent ones of the hook groups are disposed on the base part. The hook groups each include a first engaging element and a second engaging element. Each adjacent two of the engaging elements in each of the hook groups are oriented such that an element-head side of one of the two engaging elements and an element-back side of an other of the two engaging elements face each other or the respective element-back sides of the two engaging elements face each other, and each two of the engaging elements that are located across the spaced part from each other in the first direction are oriented such that the respective element-head sides of the two engaging elements face each other.

### TECHNICAL FIELD

The present invention relates to a surface fastener in which a plurality of hook-shaped engaging elements are provided continuously with a base part.

### BACKGROUND ART

House windows and the like, for example, are provided with screens to keep insects out of rooms while allowing air to pass through. In some recent-year cases, insect repellents may be attached to screens. Such an insect repellent or a package or casing having an insect repellent thereinside (hereinafter, an insect repellent, a package or casing, and other peripheral elements are collectively referred to as an insect repellent including peripheries) may be attached to a screen net by using a surface fastener product serving as means for attaching the insect repellent including peripheries to a net and provided as a combination of a hook member (male member) and a loop member (female member). The hook member includes a plurality of hook-shaped engaging elements. The loop member includes a plurality of loops and is engageable with the hook member. An exemplary surface fastener product to be attached to a screen net is disclosed in Japanese Unexamined Patent Application Publication No. 2014-236859 (PTL 1).

To attach an insect repellent including peripheries to a screen net by using such a known surface fastener product including a hook member and a loop member as disclosed in PTL 1, the hook member is first fixed to the insect repellent including peripheries, and the hook member thus fixed to the insect repellent including peripheries is made to engage with the loop member with the screen net placed in between. Accordingly, the engaging elements of the hook member and/or the loops of the loop member pass through meshes of the screen, and the hook member and the loop member engage with each other. Thus, the insect repellent including peripheries is successfully attached to the screen net by using the surface fastener product.

### CITATION LIST

### Patent Literature

PTL 1: Japanese Unexamined Patent Application Publication No. 2014-236859

### SUMMARY OF INVENTION

### Technical Problem

To attach an insect repellent including peripheries to a screen net by using the surface fastener product including the hook member and the loop member as described above, for example, while the loop member is held by a hand from the outer side of the screen, the hook member needs to be brought close to the loop member from the inner side of the screen and be made to engage with the loop member. Depending on factors such as the place of installation of the screen or the size of the screen, it is difficult or impracticable to hold the loop member by a hand from the outer side of the screen. In such a situation, the surface fastener product may be useless for attaching the insect repellent including peripheries to the screen.

Another problem may occur when an insect repellent including peripheries once attached to a screen by using the surface fastener product is detached from the screen to, for example, change the place of attachment thereof. In such a situation, a stress or the like applied in peeling the hook member and the loop member from each other may cause the loop member placed on the outer side of the screen to go off somewhere to be lost, resulting in incapability of reattaching the insect repellent including peripheries to the screen.

The present invention has been conceived in view of the above problems in the known art, and an object of the present invention is to provide a surface fastener that allows a member, such as an insect repellent including peripheries, to be attached to and detached from a screen net with no use of a loop member including a plurality of loops.

### Solution to Problem

To achieve the above object, the present invention provides a surface fastener including a base part and a plurality of hook-shaped engaging elements, the engaging elements being integrally formed with the base part. The surface fastener is characterized in that each two or more of the engaging elements are arranged closely side by side in a first direction and make up a hook group; a plurality of the hook groups with at least one spaced part provided between each adjacent two of the hook groups in the first direction are disposed on the base part; the engaging elements each include a stem portion and an engaging head, the stem portion projecting from the base part, the engaging head extending from a distal end portion of the stem portion while curving in one direction into a crook shape; the hook groups each include at least one first engaging element and at least one second engaging element, the engaging head of the first engaging element curving toward one side in the first direction, the engaging head of the second engaging element curving toward an other side in the first direction; and letting a side of each of the engaging elements in the first direction on which the engaging head extends from the stem portion be an element-head side and a side of the engaging element in the first direction that is opposite the element-head side be an element-back side, each adjacent two of the engaging elements in each of the hook groups are oriented such that the element-head side of one of the two engaging elements and the element-back side of an other of the two engaging elements face each other or the respective element-back sides of the two engaging elements face each other, and each two of the engaging elements that are located across the spaced part from each other in the first direction are oriented such that the respective element-head sides of the two engaging elements face each other.

In the surface fastener according to the present invention, it is preferable that the two or more engaging elements making up the hook group be connected to each other at respective proximal end portions of the engaging elements, the proximal end portions of the engaging elements being continuous with the base part.

Furthermore, it is preferable that the stem portion have a pair of sidewall surfaces each extending in the first direction; the stem portion include a pair of rib portions provided on the respective sidewall surfaces, the rib portions projecting from the base part and extending along the stem portion; and the rib portions of the two or more engaging elements making up the hook group be connected to each other.

Furthermore, it is preferable that a top end face of each of the engaging elements seen from the one side or the other side in the first direction form a curved surface that is convex away from the base part.

According to the present invention, it is preferable that a distal end portion of the engaging head of each of the engaging elements seen from the one side or the other side in the first direction have a curved surface that is convex toward the base part; a distal end face of the engaging head of the engaging element seen in a heightwise direction of the engaging element form a curved surface that is convex toward the one side or the other side in the first direction; and the distal end portion of the engaging head of the engaging element seen in a widthwise direction of the engaging element have a curved surface that is convex toward the base part, the widthwise direction being orthogonal to the first direction and to the heightwise direction.

Furthermore, it is preferable that, letting a maximum size of each of the engaging elements in a heightwise direction that is measured from the base part be a maximum heightwise size of the engaging element and a heightwise position of the engaging element that is at ½ of the maximum heightwise size be a middle position, the maximum heightwise size of the engaging element be set greater than four times a size of the engaging element in the first direction at the middle position, and the size of the engaging element in the first direction at the middle position is set greater than a size of the stem portion in a widthwise direction.

Furthermore, it is preferable that the first engaging element and the second engaging element included in each of the hook groups are of equal number.

### Advantageous Effects of Invention

The surface fastener according to the present invention allows a member, such as an insect repellent including peripheries, to be attached to and detached from a screen net with no use of a loop member including a plurality of loops.

### BRIEF DESCRIPTION OF DRAWINGS

FIG. 1 is a schematic side view of a surface fastener according to an example of the present invention.

FIG. 2 is a plan view of the surface fastener illustrated in FIG. 1.

FIG. 3 is a front view of the surface fastener illustrated in FIG. 1.

FIG. 4 is an enlarged side view of a hook group included in the surface fastener illustrated in FIG. 1.

FIG. 5 is an enlarged perspective view of an engaging element included in the surface fastener illustrated in FIG. 1.

FIG. 6 is a schematic diagram of a manufacturing apparatus configured to manufacture the surface fastener illustrated in FIG. 1.

FIG. 7 is a schematic diagram of a die wheel included in the manufacturing apparatus illustrated in FIG. 6.

FIG. 8 is a schematic sectional view of part of the die wheel illustrated in FIG. 7.

### DESCRIPTION OF EMBODIMENTS

A preferred embodiment of the present invention will now be described in detail with examples and with reference to the drawings.

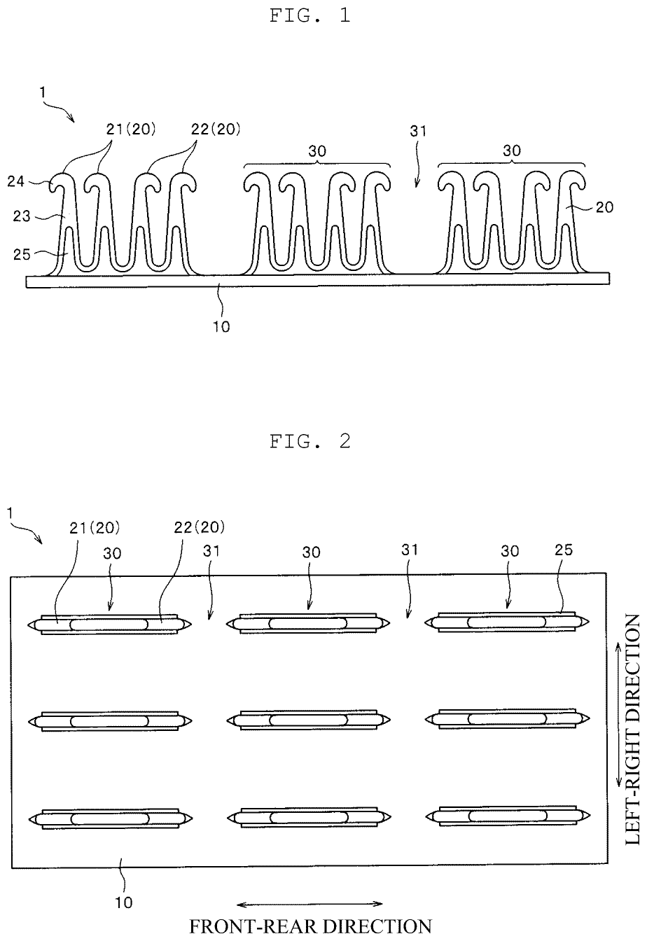

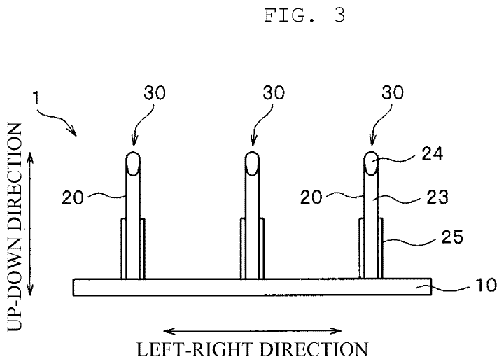

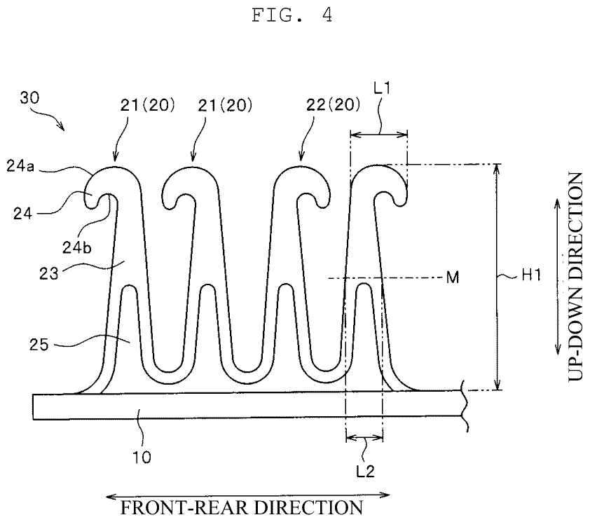

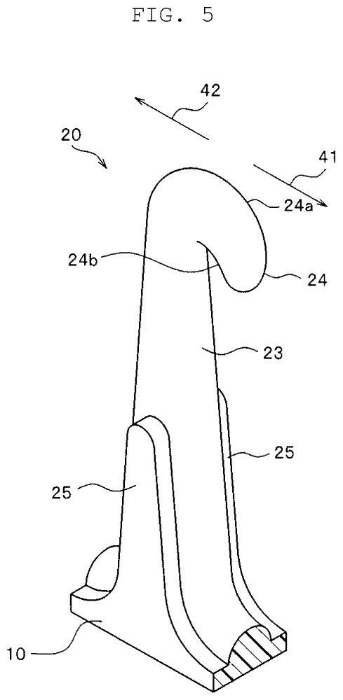

FIG. 1 is a schematic side view of a surface fastener according to an example. FIGS. 2 and 3 are a plan view and a front view, respectively, of the surface fastener according to the example. FIG. 4 is an enlarged side view of a hook group included in the surface fastener. FIG. 5 is an enlarged perspective view of an engaging element included in the surface fastener.

In the following description, the front-rear direction is a direction (first direction) parallel to a machining direction MD, in which the surface fastener is to be transported in a process of manufacturing the surface fastener, and is parallel to a direction in which engaging elements are arrayed in the below-described hook group.

The left-right direction refers to the widthwise direction that is orthogonal to the lengthwise direction and parallel to the upper surface (first surface) or the lower surface (second surface) of a base part of the surface fastener. Herein, the left-right direction and the widthwise direction correspond to an orthogonal direction CD, which is orthogonal to the machining direction MD.

The up-down direction is the heightwise direction (or the thicknesswise direction of the base part) parallel to the direction orthogonal to the upper surface or the lower surface of the base part and is orthogonal to the front-rear direction and to the left-right direction. Herein, with reference to the base part, a side toward which engaging elements project is defined as the upper side, and a side opposite the upper side is defined as the lower side.

A surface fastener 1 according to the present example is intended to attach an insect repellent including peripheries (not illustrated) to a screen (not illustrated) and is to be fixed to the insect repellent including peripheries. The surface fastener 1 includes a plurality of engaging elements 20, which are to be directly made to engage with a screen net. Therefore, the surface fastener 1 enables an insect repellent including peripheries to be attached to a screen with no use of a loop member. In the present invention, the term “insect repellent including peripheries” encompasses an insect repellent itself, a package and casing that houses the insect repellent, and other peripheral elements.

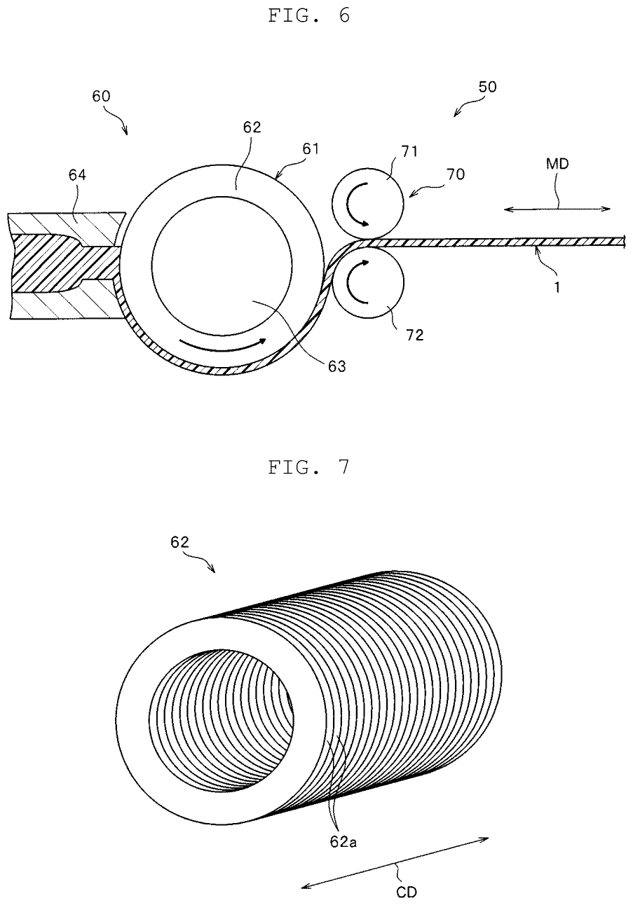

The surface fastener 1 according to the present example includes a base part 10, which is made of synthetic resin and has a flat plate shape; and the plurality of engaging elements 20, which each have a hook shape and are integrally formed with the base part 10. A plurality of hook groups 30, which each consist of two or more engaging elements 20 are disposed on the base part 10. The surface fastener 1 according to the present example is manufactured by using a manufacturing apparatus 50. The manufacturing apparatus 50 includes a molding device 60, which is illustrated in FIG. 6 and will be described separately below.

The surface fastener 1 according to the present example is made of polypropylene resin, which is weather resistant. In the present invention, the material for the surface fastener 1 is not limited and may be, for example, thermoplastic resin such as polyamide resin, polyester resin, polypropylene resin, PVC resin, ABS resin, polyethylene resin, or a copolymer of any of the foregoing. The surface fastener 1 may preferably be weather resistant.

The base part 10 has a thin flat plate shape with a small thicknesswise size (the size in the up-down direction). The upper surface and the lower surface of the base part 10 are both flat. In a plan view, from above, of the surface fastener 1, the base part 10 has an oblong rectangular shape that is longer in the machining direction MD, which is parallel to a transport path provided in the manufacturing apparatus 50, than in the orthogonal direction CD, which is orthogonal to the machining direction MD.

The base part 10 according to the present example has a thicknesswise size of 0.1 mm or greater and 0.4 mm or smaller, preferably 0.15 mm or greater and 0.35 mm or smaller. If the base part 10 has a thicknesswise size of 0.1 mm or greater, the base part 10 is ensured to have an appropriate strength and is therefore capable of stably supporting the plurality of hook groups 30. Such a base part 10 facilitates the attaching of the surface fastener 1 to an insect repellent including peripheries. On the other hand, if the base part 10 has a thicknesswise size of 0.4 mm or smaller, the molding of the surface fastener is facilitated.

The engaging elements 20 according to the present example each include a stem portion 23, which projects from the base part 10; an engaging head 24, which extends from the distal end portion of the stem portion 23 while curving; and a pair of left and right rib portions 25, which are located on the left and right sides, respectively, of the stem portion 23. The engaging element 20 has a substantially J shape in a side view (see FIGS. 1 and 4) of the engaging element 20 seen from either of the left and right sides.

The engaging element 20 according to the present example is narrowly elongated in the up-down direction with the up-down-direction size (hereinafter referred to as the heightwise size) being greater than that of, for example, a generally known hook-shaped (J-shaped) engaging element. Such an engaging element 20 that is narrowly elongated in the up-down direction is easy to bend in a direction orthogonal to the up-down direction; that is, in the front-rear direction, the left-right direction, and the like. In the present invention, the largest value as the heightwise size of the engaging element 20 that is measured from the base part 10 is defined as the maximum heightwise size, H1, of the engaging element 20. Furthermore, a heightwise position of the engaging element 20 that is at ½ of the maximum heightwise size H1 is defined as the middle position, M, of the engaging element 20.

The stem portion 23 of the engaging element 20 extends from the base part 10 straightly upward in the up-down direction. The stem portion 23 has a pair of left and right sidewall surfaces, which face toward the respective sides in the left-right direction. The stem portion 23 according to the present example stands upright in the up-down direction. The left and right sidewall surfaces of the stem portion 23 each extend in the front-rear direction. Herein, the situation where the stem portion 23 stands upright in the up-down direction refers to a situation where the center line of the stem portion 23 in terms of the left-right direction extends in the up-down direction. In the present invention, the stem portion may extend at least upward from the base part and may not necessarily need to extend upright in the up-down direction. For example, with reference to the up-down direction, the stem portion may be slightly tilted frontward or rearward, or toward one side in the left-right direction.

In a side view (FIG. 4, for example) of the engaging element 20, the lengthwise size (the size in the front-rear direction) of the stem portion 23 gradually decreases as the distance from the base part 10 increases (that is, in the upward direction). The widthwise size of the stem portion 23 is set to a constant value from the proximal end portion of the stem portion 23, where the stem portion 23 is connected to the base part 10, to the distal end portion (the end portion adjoining the engaging head 24) of the stem portion 23. For example, the widthwise size of the stem portion 23 according to the present example is set to 0.2 mm or greater and 0.4 mm or smaller. Herein, the widthwise size of the stem portion 23 refers to the distance between the left and right sidewall surfaces of the stem portion 23.

The engaging head 24 of the engaging element 20 has a crook shape extending from the distal end portion (upper end portion) of the stem portion 23 while curving toward only one side in the front-rear direction. In the side view (FIG. 4) of the engaging element 20, the engaging head 24 has an outer peripheral surface 24a, which has an arc shape or a substantially arc shape; and an inner peripheral surface 24b, which is located opposite the outer peripheral surface 24a in such a manner as to face the base part 10 from the engaging head 24 and has an arc shape or a substantially arc shape. For example, the outer peripheral surface 24a of the engaging head 24 according to the present example forms a curved surface with a curvature radius of 0.2 mm or greater and 0.5 mm or smaller, and the inner peripheral surface 24b of the engaging head 24 forms a curved surface with a curvature radius of 0.05 mm or greater and 0.2 mm or smaller.

The engaging head 24 is shaped such that the distance between the outer peripheral surface 24a and the inner peripheral surface 24b gradually decreases from the proximal end portion of the engaging head 24, where the engaging head 24 is connected to the stem portion 23, to the distal end portion of the engaging head 24.

The outer peripheral surface 24a of the engaging head 24 includes a top end face (upper end face) facing upward and located in a central part of the engaging head 24 in terms of the front-rear direction. The outer peripheral surface 24a of the engaging head 24 forms a curved surface having an arc shape or a substantially arc shape in the side view (FIG. 4), with the top end face thereof being at the highest position.

In a front view (see FIG. 3, for example) or a rear view of the engaging element 20, the top end face of the engaging head 24 according to the present example forms a curved surface that is convex upward such that a central part thereof in terms of the widthwise direction (left-right direction) is at the highest position with reference to the widthwise direction.

As described above, the outer peripheral surface 24a of the engaging head 24 of the engaging element 20 according to the present example has an arc shape or a substantially arc shape in the side view of the engaging element 20, with the top end face thereof being at the highest position. Furthermore, the top end face of the engaging head 24 forms a curved surface that is convex with reference to the widthwise direction. Hence, for example, in the process of bringing the surface fastener 1 according to the present example close to a screen net and make the surface fastener 1 engage with the screen net, even if, for example, the engaging heads 24 of the engaging elements 20 fail to be directly inserted into meshes of the screen and interfere with the screen net (threads such as wires), the engaging heads 24 of the engaging elements 20 slip on the net and easily undergo elastic deformation such that the engaging elements 20 narrowly elongated in the up-down direction bend in any directions that are orthogonal to the up-down direction (for example, in the front-rear direction and the left-right direction). Therefore, the engaging elements 20 are easily insertable into meshes of the screen.

In the front view (FIG. 3) or the rear view of the engaging element 20 according to the present example, the distal end portion of the engaging head 24 has a curved surface that is convex downward with reference to the widthwise direction such that a central part of the distal end portion in terms of the widthwise direction projects downward, that is, toward the base part 10, to the most extent.

In the plan view (see FIG. 2) of the engaging element 20, the distal end portion of the engaging head 24 has a curved surface that is convex frontward or rearward with reference to the widthwise direction such that a central part of the distal end portion in terms of the widthwise direction projects frontward or rearward to the most extent. In the side view (see FIGS. 1 and 4) of the engaging element 20, the distal end portion of the engaging head 24 has a curved surface that is convex downward with reference to the front-rear direction such that a central part of the distal end portion in terms of the front-rear direction projects downward, that is, toward the base part 10, to the most extent.

As described above, the distal end portion of the engaging head 24 has a narrow curved shape that is convex downward and frontward or rearward. Therefore, the distal end portion of the engaging head 24 is easily made to undergo elastic deformation. Hence, in the process of making the surface fastener 1 according to the present example engage with a screen net, when the engaging elements 20 are inserted into meshes of the screen, the screen net (threads) easily goes over the distal end portions of the engaging heads 24 and move to the inner peripheral surfaces 24b of the engaging heads 24. Thus, the engaging elements 20 of the surface fastener 1 are engageable with the screen net with increased ease. In the present invention, the distal end portion of each of the engaging heads may have a curved surface that is convex toward only one side or may be shaped with no curved surface.

In the side view (see FIG. 4 for example) of the engaging element 20 according to the present example, the engaging head 24 has a lengthwise size (the size in the front-rear direction) L1 that is greater than the lengthwise size, L2, of the engaging element 20 at the middle position M and is set smaller than twice the lengthwise size L2 of the engaging element 20 at the middle position M. Specifically, the lengthwise size L1 of the engaging head 24 is set to 0.5 mm or greater and 1.0 mm or smaller. Herein, the lengthwise size L1 of the engaging head refers to, in the side view of the engaging element 20, the maximum size in the front-rear direction from a point of the outer peripheral surface 24a of the engaging head 24 that faces frontward (including substantially frontward) to a point of the outer peripheral surface 24a that faces rearward (including substantially rearward) in a region on the upper side, in the up-down direction, relative to the terminal end of the engaging head 24.

If the lengthwise size L1 of the engaging head 24 is greater than the lengthwise size L2 of the engaging element 20 at the middle position M, the engaging head 24 is provided with an appropriate strength. Furthermore, such an engaging head 24 is easily engageable with the screen net, making the engaging element 20 stably engageable with the net. If the lengthwise size L1 of the engaging head 24 is smaller than twice the lengthwise size L2 of the engaging element 20 at the middle position M, the engaging head 24 of the engaging element 20 is easily insertable into a mesh of the screen.

The rib portions 25 of each engaging element 20 are provided on the respective left and right sidewall surfaces of the stem portion 23 and project upward from the base part 10 along the stem portion 23. The left and right rib portions 25 are continuous with the stem portion 23 and bulge from the respective left and right sidewall surfaces of the stem portion 23 outward in the left-right direction. The rib portions 25 each have a lengthwise size (a size in the front-rear direction) that is gradually reduced in a direction away from the base part 10, excluding the priximal end portion (lower end) of the rib portion 25 where the rib portion 25 is connected to the base part 10.

The left and right rib portions 25 according to the present example each have a widthwise size (a size in the left-right direction) of 50% or smaller of the widthwise size of the stem portion 23. Specifically, the widthwise size of the rib portion 25 is set to 0.05 mm or greater and 0.20 mm or smaller, preferably 0.10 mm or greater and 0.15 mm or smaller.

If the left and right rib portions 25 each have a widthwise size of 0.01 mm or greater, an increased strength is provided to the engaging element 20. Furthermore, in the process of molding the surface fastener 1 by using the below-described manufacturing apparatus 50, molten synthetic resin is easily feedable to distal end portions of cavities provided for forming the narrowly elongated engaging elements 20 (that is, to the distal end portions of the engaging heads 24). Thus, the engaging elements 20 are stably moldable into predetermined shapes. If the left and right rib portions 25 each have a widthwise size of 50% or smaller of the widthwise size of the stem portion 23 or each have a widthwise size of 0.2 mm or smaller, such rib portions 25 reduce the probability that the presence of the rib portions 25 may lower the flexibility (easiness in undergoing elastic deformation) of the engaging element 20 in the left-right direction and in the front-rear direction.

The maximum heightwise size (the largest value as the heightwise size) of the left and right rib portions 25 that is measured from the base part 10 is set to 5% or greater and 50% or smaller, preferably 25% or greater and 50% or smaller, of the maximum heightwise size H1 of the engaging element 20. If the rib portions 25 each have a maximum heightwise size of 5% or greater, preferably 25% or greater, of the maximum heightwise size H1 of the engaging element 20, an increased strength is effectively provided to the engaging element 20. Furthermore, in the process of molding the surface fastener 1, molten synthetic resin is easily feedable to the distal end portions of the cavities. If the rib portions 25 each have a maximum heightwise size of 50% or smaller of the maximum heightwise size H1 of the engaging element 20, such rib portions 25 reduces the probability that the presence of the rib portions may reduce the flexibility (easiness in undergoing elastic deformation) of the engaging element 20 in the front-rear direction and in the left-right direction.

As described above, the engaging elements 20 according to the present example are provided on the base part 10 and each have a substantially J shape that is narrowly elongated in the up-down direction. For example, the engaging element 20 according to the present example is shaped with a maximum heightwise size H1 thereof that is greater than four times, preferably five times, the lengthwise size L2 of the engaging element 20 at the middle position M. In such a case, the lengthwise size L2 of the engaging element 20 at the middle position M is set greater than the widthwise size of the stem portion 23 (the distance between the left and right sidewall surfaces of the stem portion 23). Specifically, the maximum heightwise size H1 of the engaging element 20 is set to 1.5 mm or greater and 3.5 mm or smaller, preferably 2.0 mm or greater and 3.0 mm or smaller. The lengthwise size L2 of the engaging element 20 at the middle position M is set to 0.3 mm or greater and 0.6 mm or smaller.

In the surface fastener 1 according to the present example, the base part 10 has thereon the hook groups 30 and spaced parts 31. The hook groups 30 each consist of two or more engaging elements 20 that are arranged closely side by side in the front-rear direction. The spaced parts 31 are each provided between corresponding two hook groups 30 that are adjacent to each other in the front-rear direction. In the present example, each hook group 30 consists of four engaging elements 20 arranged side by side in the front-rear direction. The four engaging elements 20 in each hook group 30 are oriented such that the stem portions 23 (particularly the center lines of the respective stem portions 23 in terms of the left-right direction) are parallel to one another. In the surface fastener 1 according to the present example, a single base part 10 having an oblong rectangular shape in plan view has nine hook groups 30 that are arrayed in the front-rear direction and in the left-right direction to form a grid pattern (see FIG. 2).

The engaging elements 20 according to the present example include first engaging elements 21 and second engaging elements 22. The engaging head 24 of each of the first engaging elements 21 extends from the stem portion 23 while curving rearward (toward one side in the first direction). The engaging head 24 of each of the second engaging elements 22 extends from the stem portion 23 while curving frontward (toward the other side in the first direction). Focusing on the four engaging elements 20 making up each of the hook groups 30, as illustrated in FIG. 4 for example, one of the engaging elements 20 that is at the rearmost position is defined as the engaging element 20 at the first position. Furthermore, the others are defined, in the frontward order from the engaging element 20 at the first position, as the engaging element 20 at the second position, the engaging element 20 at the third position, and the engaging element 20 at the fourth position.

In each hook group 30 according to the present example, the engaging elements 20 at the first and second positions correspond to the first engaging elements 21, and the engaging elements 20 at the third and fourth positions correspond to the second engaging elements 22. The hook group 30 according to the present example particularly includes an equal number of the first engaging elements 21 and the second engaging elements 22. Each hook group 30 consists of engaging elements 20 of two kinds that are different in the orientations of the engaging heads 24. Thus, the hook group 30 is firmly engageable with a screen net, and the hook group 30 once engaged with a net is therefore hard to come off the net.

To express the orientation of each of the engaging elements 20 according to the present example, a side of the engaging element 20 in the front-rear direction (first direction) on which the engaging head 24 extends from the stem portion 23 is defined as the “element-head side 41” of the engaging element 20, and a side of the engaging element 20 in the front-rear direction (first direction) that is opposite the element-head side 41 is defined as the “element-back side 42” (see FIG. 5). Under such definitions, regarding the four engaging elements 20 making up each of the hook groups 30, each adjacent two of the engaging elements 20 in terms of the front-rear direction are oriented such that the element-head side 41 and the element-back side 42 face each other or the respective element-back sides 42 face each other.

Specifically, in each hook group 30, the first engaging elements 21 at the first and second positions that are adjacent to each other in the front-rear direction are oriented such that the element-head side 41 and the element-back side 42 face each other (more specifically, the element-back side 42 of the first engaging element 21 at the first position faces the element-head side 41 of the first engaging element 21 at the second position). The first engaging element 21 at the second position and the second engaging element 22 at the third position are oriented such that the respective element-back sides 42 face each other (more specifically, the element-back side 42 of the first engaging element 21 at the second position faces the element-back side 42 of the second engaging element 22 at the third position). The second engaging elements 22 at the third and fourth positions are oriented such that the element-head side 41 and the element-back side 42 face each other (more specifically, the element-head side 41 of the second engaging element 22 at the third position faces the element-back side 42 of the second engaging element 22 at the fourth position). In other words, each adjacent two of the engaging elements 20 in the hook group 30 are oriented such that the element-head sides 41 thereof do not face each other.

If, for example, a surface fastener in which hook groups each include two engaging elements oriented such that the respective element-head sides face each other is brought close to a screen net to make the hook groups thereof engage with the net, it is difficult to insert two or more of the threads (such as wires, metal cords, or the like) forming the net into a space between the two engaging elements whose element-head sides face each other. Consequently, at least one of the two engaging elements whose element-head sides face each other fails to engage with the screen net (threads).

In contrast, the present example employs an arrangement in which the four engaging elements 20 making up each of the hook groups 30 are oriented such that the element-head side 41 and the element-back side 42 face each other or the element-back sides 42 face each other. Therefore, in the process of bringing the surface fastener 1 close to a screen net to make the hook groups 30 engage with the net, the engaging elements 20 in the hook groups 30 are easily engageable with threads of the net. Furthermore, once the surface fastener 1 is made to engage with a screen net, the engaging elements 20 in the hook groups 30 thus engaged with the net are hard to come off the net.

On the other hand, each two engaging elements 20 located across a corresponding one of the spaced parts 31 from each other in the front-rear direction (for example, the second engaging element 22 at the fourth position in one hook group 30 and the first engaging element 21 at the first position in another hook group 30 adjacent to the one hook group 30 with the spaced part 31 in between) are oriented such that the respective element-head sides 41 face each other. Therefore, in such a case where the spaced part 31 forming a gap greater than the pitch of the engaging elements 20 is provided between each two hook groups 30, threads of the screen net are easily engageable with the two engaging elements 20 located across the spaced part 31 from each other. Furthermore, the two engaging elements 20 thus engaged with the net are hard to come off the net.

The four engaging elements 20 making up each of the hook groups 30 are connected to one another at the proximal end portions of the stem portions 23 thereof and at the proximal end portions of the left and right rib portions 25 thereof, whereby the four engaging elements 20 are continuous with one another. Thus, an increased strength is provided to each of the hook groups 30. Furthermore, in the process of molding the surface fastener 1, molten synthetic resin is easily feedable to the distal end portions of the cavities provided for forming the narrowly elongated engaging elements 20. Accordingly, the engaging elements 20 are stably moldable into predetermined shapes.

In the present example, the four engaging elements 20 making up each of the hook groups 30 are arranged in the front-rear direction at a pitch of 0.5 mm or greater and 1.5 mm or smaller. Herein, the pitch of the engaging elements 20 refers to a length in the front-rear direction in each hook group 30 from a reference position defined at the stem portion 23 of one engaging element 20 to a reference position defined at the stem portion 23 of another engaging element 20 adjacent to the one engaging element 20 in the front-rear direction. The reference position defined at the stem portion 23 of the engaging element 20 refers to a position in the stem portion 23 that is at the center in the front-rear direction (particularly, a position that is at the proximal end portion of the stem portion 23 and is at the center in the front-rear direction).

The size of the spaced part 31 in the front-rear direction (that is, the interval between two hook groups 30 that are adjacent to each other in the front-rear direction) is set greater than or equal to the pitch of the engaging elements 20 in the hook group 30 and smaller than or equal to 50% of the lengthwise size of the proximal end portion of the hook group 30 (the total lengthwise size of the proximal end portions of the four connected engaging elements 20). Specifically, the size of the spaced part 31 in the front-rear direction is set to 1.0 mm or greater and 2.0 mm or smaller. Herein, the size of the spaced part 31 in the front-rear direction (the lengthwise size) refers to the length in the front-rear direction between each adjacent two of the hook groups 30 in terms of the front-rear direction and from the reference position of the second engaging element 22 at the fourth position in one of the two hook groups 30 to the reference position of the first engaging element 21 at the first position in the other hook group 30.

The interval between each adjacent two of the hook groups 30 in terms of the left-right direction is set greater than the size of the spaced part 31 in the front-rear direction and is 1.5 mm or greater and 4.0 mm or smaller, preferably 2.5 mm or greater and 3.0 mm or smaller.

For example, known screens employ various kinds of nets forming meshes of different sizes and values (that is, numerical values related to the mesh). As a result of thorough experiments and examinations for making the surface fastener 1 engageable with increased varieties of nets, the present inventors have found that the surface fastener 1 is to be formed with the sizes and arrangements of the engaging elements 20 and the hook groups 30 that are set within the above numerical ranges.

That is, in the surface fastener 1, if the size of each of the engaging elements 20, the arrangement of the engaging elements 20 in each of the hook groups 30, and the sizes and arrangement of the hook groups 30 and the spaced parts 31 on the base part 10 are set to the sizes and positional relationships described above, the surface fastener 1 according to the present example is engageable with increased varieties of nets having different mesh-related values. Accordingly, the usability of the surface fastener 1 is increased for more versatile purposes.

Now, the manufacturing apparatus 50 configured to manufacture the surface fastener 1 according to the present example will be described with reference to FIG. 6.

The manufacturing apparatus 50 according to the present embodiment includes a molding device 60, which is configured to mold the surface fastener 1; a pickup roller 70, which is configured to peel the surface fastener 1 from the molding device 60; and a cutting device (not illustrated), which is provided on the downstream side relative to the pickup roller 70.

The molding device 60 according to the present embodiment includes a die wheel 61, which is driven to rotate in one direction; and a nozzle unit 64, which is provided facing the outer peripheral surface of the die wheel 61. The die wheel 61 includes a wheel part 62, which serves as a die member; and a rotatable driving roller 63, which is configured to rotate the wheel part 62 at a predetermined speed and in the one direction.

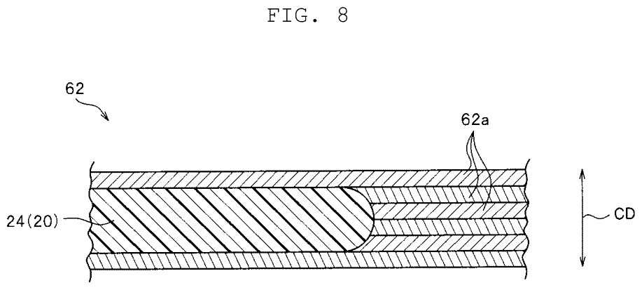

As illustrated in FIG. 7, the wheel part 62 is formed of a plurality of doughnut-shaped ring plates (die plates) 62a. The ring plates 62a, each having a predetermined thickness, are stacked in the orthogonal direction CD or the direction of the rotation axis of the die wheel 61, whereby the wheel part 62 has a circular columnar shape with a hollow central part.

The wheel part 62 has at the outer periphery thereof a plurality of cavities (not illustrated), where the engaging elements 20 and the hook groups 30, described above, of the surface fastener 1 are moldable. The cavities for molding the engaging elements 20 and the hook groups 30 that are provided at the outer periphery of the wheel part 62 are arranged in correspondence with the engaging elements 20 and the hook groups 30 of the surface fastener to be manufactured. Furthermore, the cavities for molding the engaging elements 20 each have a narrowly elongated shape extending from the outer peripheral surface of the die wheel 61 toward the center of rotation of the die wheel 61 in conformity with the shape of the engaging element 20.

In the wheel part 62 according to the present example, the cavities for molding the stem portions 23 and the engaging heads 24 of the engaging elements 20 are each provided by, for example, stacking four ring plates 62a as illustrated in FIG. 8, which schematically illustrates a part of a section of the wheel part 62. In the present case, the ring plates 62a each have a thickness of 0.05 mm or greater and 1.0 mm or smaller.

Hence, in the process of molding the surface fastener 1 by using the die wheel 61, even if the stem portions 23 are to be formed with a widthwise size as small as 0.2 mm or greater and 0.4 mm or smaller as described above, such stem portions 23 and engaging heads 24 are moldable accurately and stably in predetermined shapes and sizes. That is, the use of the die wheel 61 according to the present example enables stable molding of the top end face of each of the engaging heads 24 into a curved surface that is convex upward with reference to the widthwise direction, and also enables stable molding of the distal end portion of each of the engaging heads 24 into a narrow curved shape that is convex downward and also convex frontward or rearward.

The die wheel 61 according to the present example includes a cooling jacket (not illustrated) that allows cooling liquid to flow through the inside of the rotatable driving roller 63 so that the surface fastener 1 molded on the outer peripheral surface of the die wheel 61 is efficiently cooled. Below the die wheel 61 is provided a cooling-liquid tank, which is not illustrated, so that at least a portion of the die wheel 61 is immersible in the cooling liquid in the cooling-liquid tank.

The nozzle unit 64 is configured to continuously feed molten synthetic resin to the die wheel 61. Specifically, the nozzle unit 64 includes a passageway that allows molten synthetic resin to flow through, a nozzle end face that is located facing the die wheel 61, and a feed port that opens at the nozzle end face. The nozzle unit 64 is capable of continuously extruding (or discharging) molten synthetic resin from the feed port toward the die wheel 61.

The pickup roller 70 includes a pair of an upper nipping roller 71 and a lower nipping roller 72, which are configured to nip the surface fastener 1 molded on the die wheel 61 from above and below and pull the surface fastener 1. The upper nipping roller 71 and the lower nipping roller 72 each have at the outer periphery thereof a surface layer, which is not illustrated but is made of elastomer such as polyurethane elastomer.

The cutting device, not illustrated but provided below the pickup roller 70, includes a cutter unit that is movable in the up-down direction. In the cutting device, the cutter unit is to be lowered toward the surface fastener 1 transported thereto, whereby the molded surface fastener 1 is cut into pieces of a predetermined size.

Now, a method of manufacturing the surface fastener 1 by using the above-described manufacturing apparatus 50 including the molding device 60 and the pickup roller 70 will be described.

In the method of manufacturing the surface fastener 1 according to the present example, a molten synthetic resin material is first continuously fed from the feed port of the nozzle unit 64 toward the outer peripheral surface of the die wheel 61. In this step, the die wheel 61 is driven by the rotatable driving roller 63 to rotate in one direction (counterclockwise in FIG. 6) and at a predetermined rotation speed.

Thus, the molten synthetic resin fed from the nozzle unit 64 is molded into a base part 10 of a surface fastener 1 between the nozzle unit 64 and the die wheel 61. Furthermore, the synthetic resin flows into the plurality of cavities provided in the outer peripheral surface of the die wheel 61, thereby being molded into a plurality of engaging elements 20 and hook groups 30 integrally with the base part 10.

In the surface fastener 1 according to the present example, the four engaging elements 20 making up each of the hook groups 30 each have the pair of left and right rib portions 25 and are connected to one another at the proximal end portions of the stem portions 23 and at the proximal end portions of the left and right rib portions 25. Therefore, the cavities provided in the die wheel 61 for molding such engaging elements 20 are each allowed to have an increased opening area at the outer peripheral surface of the die wheel 61. Hence, even in the case where the engaging elements 20 to be molded by using the die wheel 61 each have a substantially J shape that is narrowly elongated in the up-down direction as described above, the molten synthetic resin is stably feedable from the nozzle unit 64 into the narrowly elongated cavities provided in the die wheel 61 for molding the engaging elements 20. Thus, a plurality of engaging elements 20 and hook groups 30 having predetermined shapes are stably moldable.

Subsequently, the surface fastener 1 molded on the outer peripheral surface of the die wheel 61 is hardened (solidified) by being cooled on the die wheel 61 while rotating thereon. Subsequently, the surface fastener 1 is continuously peeled from the die wheel 61 by the pickup roller 70.

The surface fastener 1 exited from the pickup roller 70 is then transported toward the cutting unit, not illustrated, and is cut into pieces of a predetermined size by the cutting unit before being collected. In the present invention, the surface fastener 1 exited from the pickup roller 70 may be collected without being cut but by being wound into a roll by a collecting roller or the like.

In the present invention, the molding device to be used in manufacturing the surface fastener and the method of manufacturing the surface fastener are not limited to those of the present example and may be changed in any way. For example, in the present example, the surface fastener 1 is molded by continuously feeding molten synthetic resin from the nozzle unit 64 toward the die wheel 61. Alternatively, in the present invention, the surface fastener 1 may be molded by using a pair of upper and lower molding rollers at least one of which serves as the die wheel 61 according to the above example, and molten synthetic resin may be continuously fed from the nozzle unit toward the gap between the pair of upper and lower molding rollers.

Such a manufacturing method also provides the surface fastener 1 according to the present example illustrated in FIGS. 1 to 3. The surface fastener 1 according to the present example thus manufactured is to be fixed to an insect repellent including peripheries, which refers to an insect repellent and a package or the like that houses the insect repellent, by using any element such as adhesive or an adhesive member (adhesive tape). In the present invention, the method and means for fixing the surface fastener 1 to an insect repellent including peripheries are not limited.

The surface fastener 1 according to the present example thus attached to an insect repellent including peripheries is brought close to one side of a screen net, and the plurality of engaging elements 20 making up the hook groups 30 of the surface fastener 1 are made to pass through meshes of the screen, whereby the hook groups 30 of the surface fastener 1 are successfully made to engage with the screen net. Such a surface fastener 1 according to the present example is engageable with a screen net in either orientation, with the front-rear direction (machining direction MD) of the surface fastener 1 being horizontal or vertical relative to the screen net.

In the present example particularly, the engaging elements 20 each have a shape narrowly elongated in the up-down direction, with the outer peripheral surface 24a (particularly the top end face) of the engaging head 24 thereof forming a curved surface curving with reference to the front-rear direction and the left-right direction. Therefore, even if, for example, the engaging heads 24 of the engaging elements 20 interfere with the threads such as wires of the screen net in the process of making the engaging elements 20 pass through meshes of the screen, the engaging elements 20 are bendable, relative to the threads, in any orthogonal direction (including the front-rear direction and the left-right direction) that is orthogonal to the heightwise direction of the engaging elements 20. Hence, the engaging elements 20 easily pass through meshes of the screen without being caught by the threads.

To summarize, the surface fastener 1 according to the present example includes the hook groups 30 that are firmly engageable with a screen net without employing the known loop member, and ensures stable retainment of the state of engagement between the hook groups 30 and the net. Therefore, the work of attaching an insect repellent including peripheries to a screen is facilitated, regardless of the place of installation of the screen in the house and any other factors. Furthermore, the omission of the loop member reduces the manufacturing cost and the amount of plastic consumption. Note that the surface fastener 1 according to the present example once engaged with a screen net is easily removable from the screen by, for example, peeling the surface fastener 1 from the net in such a manner as to remove the hook groups 30 of the surface fastener 1 one by one from the net.

As described above, the surface fastener 1 according to the present example includes nine hook groups 30 arranged on the base part 10 at predetermined intervals and in a grid pattern, and the hook groups 30 each consists of four engaging elements 20 arrayed in the front-rear direction at regular intervals and at regular arrangement. Furthermore, as described above, the engaging elements 20 each have a shape narrowly elongated in the up-down direction and are easily bendable in directions orthogonal to the heightwise direction of the engaging elements 20. Such a structure makes the surface fastener 1 according to the present example easily engageable with varieties of nets having different mesh-related values, and therefore greatly increases the convenience of insect repellents including peripheries to be attached to screens.

The present invention is not limited to the above example in any way and may be modified in various ways as long as such modifications are based on substantially the same configuration and produce the same advantageous effects as the present invention. For example, in the present invention, the size and shape of the surface fastener and the number and arrangement of the hook groups to be included in a single surface fastener 1 are not limited and may be changed.

In the surface fastener 1 according to the above example, the hook groups 30 each include the first engaging elements 21 and the second engaging elements 22 between which the orientations of the engaging heads 24 are opposite. Furthermore, the hook groups 30 each consist of four engaging elements 20. In the present invention, however, the number of the engaging elements making up each hook group is not limited, as long as the hook group includes a first engaging element and a second engaging element. Preferably, the engaging elements in each hook group according to the present invention may be provided in an even number so that the first engaging elements and the second engaging elements are of equal number. Such a hook group consisting of the first engaging elements and the second engaging elements that are of equal number is firmly engageable with a screen net and is hard to come off the net once engaged with the net.

While the surface fastener 1 according to the above example is used to attach an insect repellent including peripheries to a screen, the surface fastener according to the present invention may be used to attach any member or component other than the insect repellent including peripheries to a screen or any net other than the screen net.

### REFERENCE SIGNS LIST

1 surface fastener
10 base part
20 engaging element
21 first engaging element
22 second engaging element
23 stem portion
24 engaging head
24a outer peripheral surface
24b inner peripheral surface
25 rib portion
30 hook group
31 spaced part
41 element-head side
42 element-back side
50 manufacturing apparatus
60 molding device
61 die wheel
62 wheel part
62a ring plate (die plate)
63 rotatable driving roller
64 nozzle unit
70 pickup roller
71 upper nipping roller
72 lower nipping roller
H1 maximum heightwise size of engaging element
L1 lengthwise size of engaging head
L2 lengthwise size of engaging element at middle position
M middle position of engaging element

1. A surface fastener including a base part and a plurality of hook-shaped engaging elements, the engaging elements being integrally formed with the base part, wherein:
each two or more of the engaging elements are arranged closely side by side in a first direction and make up a hook group;
a plurality of the hook groups and at least one spaced part provided between each adjacent two of the hook groups in the first direction are disposed on the base part;
the engaging elements each include a stem portion and an engaging head, the stem portion projecting from the base part, the engaging head extending from a distal end portion of the stem portion while curving in one direction into a crook shape;
the hook groups each include at least one first engaging element and at least one second engaging element, the engaging head of the first engaging element curving toward one side in the first direction, the engaging head of the second engaging element curving toward an other side in the first direction; and
letting a side of each of the engaging elements in the first direction on which the engaging head extends from the stem portion be an element-head side and a side of the engaging element in the first direction that is opposite the element-head side be an element-back side, each adjacent two of the engaging elements in each of the hook groups are oriented such that the element-head side of one of the two engaging elements and the element-back side of an other of the two engaging elements face each other or the respective element-back sides of the two engaging elements face each other, and each two of the engaging elements that are located across the spaced part from each other in the first direction are oriented such that the respective element-head sides of the two engaging elements face each other.

2. The surface fastener according to claim 1, wherein:
the two or more engaging elements making up the hook group are connected to each other at respective proximal end portions of the engaging elements, the proximal end portions of the engaging elements being continuous with the base part.

3. The surface fastener according to claim 1, wherein:
the stem portion has a pair of sidewall surfaces each extending in the first direction;
the stem portion includes a pair of rib portions provided on the respective sidewall surfaces, the rib portions projecting from the base part and extending along the stem portion; and
the rib portions of the two or more engaging elements making up the hook group are connected to each other.

4. The surface fastener according to claim 1, wherein:
a top end face of each of the engaging elements seen from the one side or the other side in the first direction forms a curved surface that is convex away from the base part.

5. The surface fastener according to claim 1, wherein:
a distal end portion of the engaging head of each of the engaging elements seen from the one side or the other side in the first direction has a curved surface that is convex toward the base part;
a distal end face of the engaging head of the engaging element seen in a heightwise direction of the engaging element forms a curved surface that is convex toward the one side or the other side in the first direction; and
the distal end portion of the engaging head of the engaging element seen in a widthwise direction of the engaging element has a curved surface that is convex toward the base part, the widthwise direction being orthogonal to the first direction and to the heightwise direction.

6. The surface fastener according to claim 1, wherein:
letting a maximum size of each of the engaging elements in a heightwise direction that is measured from the base part be a maximum heightwise size of the engaging element and a heightwise position of the engaging element that is at ½ of the maximum heightwise size be a middle position, the maximum heightwise size of the engaging element is set greater than four times a size of the engaging element in the first direction at the middle position, and the size of the engaging element in the first direction at the middle position is set greater than a size of the stem portion in a widthwise direction.

7. The surface fastener according to claim 1, wherein:
the first engaging element and the second engaging element included in each of the hook groups are of equal number.
